(19) United States
(12) Patent Application Publication
(10) Pub. No.: US 2008/0264506 A1
(43) Pub. Date: Oct. 30, 2008

(54) System and method for using electrowetting on dielectric (EWOD) for controlling fluid in a microfluidic circuit

(76) Inventors: Timothy Beerling, San Francisco, CA (US); Kevin P. Killeen, Woodside, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/796,891

(22) Filed: Apr. 30, 2007

(51) Int. Cl. F15C 1/04; G01N 27/26

(52) U.S. Cl. 137/831; 137/827; 204/451

(57) ABSTRACT

A system for controlling fluid flow in a microfluidic circuit includes at least one microfluidic channel having a first fluid, a switch element coupled to the microfluidic channel, the switch element comprising at least one inlet, at least one outlet and a second fluid, the second fluid being immiscible with respect to the first fluid. The system also includes an actuator configured to alter the position of the second fluid, such that when in a first position, the second fluid allows the first fluid to flow from the at least one inlet to the at least one outlet, and such that when in a second position, the second fluid prevents the first fluid from flowing from the at least one inlet to the at least one outlet.

### BACKGROUND

There are many applications in which it is desirable to control the flow of a fluid and many of these applications employ one or more fluidic or microfluidic channels. An example of an application in which it is desirable to control the flow of fluid is what is referred to as a “lab on chip.” A lab on chip generally refers to a semiconductor-like chip that has fluid handling and processing capabilities. Examples of lab on chip applications include sample preparation, mixing, transport (e.g., electrokinetic-based flow, pressure-based flow, etc.) processing (e.g., DNA amplification), sensing, sample collection, etc.

It is desirable to regulate the flow of fluid in a microfluidic circuit, such as on a lab-on-chip. Flow regulation enables the lab on chip device to provide consistent performance and analytic results. It is desirable to provide simple and consistent flow regulation in such a device.

### SUMMARY

In accordance with an embodiment, a system for controlling fluid flow in a microfluidic circuit comprises at least one microfluidic channel having a first fluid, a switch element coupled to the microfluidic channel, the switch element comprising at least one inlet, at least one outlet and a second fluid, the second fluid being immiscible with respect to the first fluid. The system also comprises an actuator configured to alter the position of the second fluid, such that when in a first position, the second fluid allows the first fluid to flow from the at least one inlet to the at least one outlet, and such that when in a second position, the second fluid prevents the first fluid from flowing from the at least one inlet to the at least one outlet.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1A is a schematic diagram illustrating an embodiment of a system including a droplet of conductive liquid residing on a solid surface.

FIG. 1B is a schematic diagram illustrating the system of FIG. 1A having a different apparent contact angle.

FIG. 2A is a schematic diagram illustrating an embodiment of a switch employing a conductive liquid droplet that translates over a distance.

FIG. 2B is a schematic diagram illustrating the movement imparted to a droplet of conductive liquid as a result of the pressure change of the droplet caused by the reduction in apparent contact angle due to electrowetting.

FIG. 2C is a schematic diagram illustrating the switch of FIG. 2A after the application of a voltage.

FIG. 3A is a schematic diagram illustrating an embodiment of a switch employing a conductive liquid droplet that changes shape.

FIG. 3B is a schematic diagram illustrating the switch of FIG. 3A under an electrical bias.

FIG. 3C is a plan view illustrating the switch shown in FIGS. 3A and 3B.

FIG. 3D is a plan view illustrating the surface of the dielectric of FIG. 3C including a feature that alters the wettability of the surface with respect to the droplet.

FIG. 4A is a schematic diagram illustrating a switch element.

FIG. 4B is a schematic diagram illustrating the switch element of FIG. 4A in a second state.

FIG. 5A is a schematic diagram illustrating an alternative embodiment of a switch element.

FIG. 5B is a schematic diagram showing the switch element of FIG. 5A in a second state.

FIG. 6 is a flowchart describing a method for controlling fluid flow in a microfluidic circuit.

FIG. 7 is a block diagram illustrating a simplified lab on chip, which is an exemplary device in which one or more switch elements may be implemented.

### DETAILED DESCRIPTION

The system and method for using electrowetting on dielectric (EWOD) for controlling fluid flow in a microfluidic circuit employs dissimilar fluids in which one fluid is immiscible with respect to the other fluid. Under the influence of an electric field, one fluid will move preferentially with respect to the other fluid in order to maximize the stored capacitive energy of the system. In an embodiment, one of the fluids is a liquid. Typically one of the fluids, referred to below as a secondary fluid, or a secondary liquid, is present in small quantities, and is confined to a specific area, and will be used to control the flow of the other fluid, also referred to below as a first or primary fluid, or a primary liquid. In an embodiment, the position of the secondary fluid is changed to control the flow of the primary fluid. The position of the secondary fluid may be changed by changing the shape, or profile, of the secondary fluid while the secondary fluid remains stationary. Alternatively, the position of the secondary fluid may be changed by causing the secondary fluid to translate over a distance.

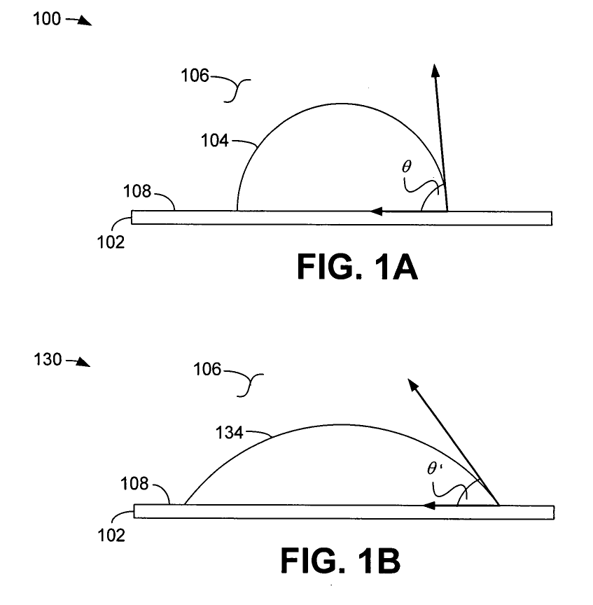

Prior to discussing embodiments in accordance with the invention, a brief discussion on the effect of electrowetting will be provided. FIG. 1A is a schematic diagram illustrating a system 100 including a droplet 104 of liquid residing on a solid surface. In the embodiments to be described below, the droplet 104 is a liquid that is located within another fluid, the flow of which is sought to be controlled. The droplet 104 is referred to as a secondary liquid, while the fluid whose flow is sought to be controlled is referred to as a primary fluid. The primary fluid can be a gas or a liquid. In this example, the primary fluid is a liquid.

To control the flow of the primary liquid, the droplet 104 is caused to change position by changing shape or by moving, depending on application. The secondary liquid should be immiscible and non-reactive with respect to the primary liquid. A high surface tension is desirable between the primary liquid and the secondary liquid. When coupled to an electrode(s) by an electric field, the primary and secondary liquids should also have a difference in capacitive energy. The capacitance created in the system will depend on both the conductivity and dielectric constant of the fluids. The electrode(s) will normally be contained, or buried, in the “floor” of a microfluidic chamber (not shown in FIG. 1A) associated with the droplet 104 and will normally be isolated with a dielectric, so only displacement currents can occur. With no electric field present, the secondary liquid should be non-wetting to the surfaces of the cavity or channel in which it is located. The non-wettability of the secondary liquid gives rise to a high contact angle, which will be described below.

The surface tension of the secondary liquid with respect to the primary liquid should be sufficient to support a pressure gradient when the secondary liquid is blocking the flow of the primary liquid. In one embodiment, the secondary liquid can be preferentially controllable with respect to the primary liquid. In this case, the secondary liquid will act to overlap the buried electrodes as much as possible in order to maximize the stored capacitive energy of the system having the first and second fluids. For example, an electrowetting effect that is preferential to the secondary liquid and which will be described below, can be used to actuate the secondary liquid. Actuation of the secondary liquid includes changing the position of the secondary liquid by altering the shape of the droplet 104, or moving the droplet 104 over a distance. The position of the secondary liquid is altered in order to maximize the capacitive energy of the system under the influence of an electric field, thus exploiting the difference in capacitance between the primary liquid and the secondary liquid with respect to an electrode(s) (not shown in FIGS. 1A and 1B). An electrowetting effect that is preferential to the primary liquid can also be employed to change the shape of the droplet 104, or move the droplet 104 over a distance.

In an embodiment, the droplet 104 can be a conductive liquid, such as mercury, gallium, a gallium-based alloy containing, for example, gallium, indium, tin, zinc, copper, or a combination of these elements with gallium. Other factors to consider when choosing a material for the droplet 104 is whether a metal is a liquid at room temperature, and the chemical reactivity of the conductive liquid with other fluids. Alternatively, the droplet 104 can be non-conductive and have a relatively high dielectric constant. The secondary fluid may also be an oil. While an oil has a relatively low dielectric constant, it can be preferentially actuated with respect to the primary liquid so long as the oil has a different dielectric constant than the primary liquid.

In an embodiment in which the droplet 104 is non-conductive, the droplet 104 should exhibit the above-mentioned characteristics and be preferentially controllable with respect to the primary fluid. Alternatively, the primary fluid should be preferentially controllable by the electrodes so that motion can be imparted to the droplet. When water is the primary liquid, oils are usually immiscible and non-reactive, and will work as the secondary liquid for some applications. It may be that the capacitive energy with a buried electrode and secondary liquid will be lower than that of the primary liquid and electrode(s), but actuation can still occur as an applied electric field will cause the secondary liquid to be “pushed out of the way” to allow for better capacitive coupling between the electrode(s) and primary liquid. The primary liquid can be, for example, water, deionized water, water including a salt, a surfactant, such as sodium dodecyl sulfate, or others.

A more detailed explanation of electrowetting will be provided below. Consider a liquid droplet 104 residing on a surface 108 of a solid 102. A contact angle, also referred to as a wetting angle, is formed where the droplet 104 meets the surface 108. The contact angle is indicated as θ and is measured at the point at which the surface 108, liquid 104 and fluid 106 meet. The fluid 106 can be, in this example, the primary fluid, and can be either a liquid or a gas. The fluid 106 forms the atmosphere surrounding the droplet 104. A high contact angle, as shown in FIG. 1A, is formed when the droplet 104 contacts a surface 108 that is referred to as relatively non-wetting, or less wettable. The wettability is generally a function of the material of the surface 108 and the material from which the droplet 104 is formed, and is specifically related to the surface tension of the fluid 106.

The fluid 106 typically is wetting with respect to the surface 108, and to the walls and roof (to be described below) of a switch structure that contains the droplet 104 in a fluid channel, or fluid cavity. Another way of saying this is that capillary forces can draw the primary fluid 106 into a microfluidic network.

FIG. 1B is a schematic diagram 130 illustrating the system 100 of FIG. 1A having a different contact angle. In FIG. 1B, the droplet 134 is more wettable with respect to the surface 108 than the droplet 104 is with respect to the surface 108, and therefore forms a lower contact angle, referred to as θ′. As shown in FIG. 1B, the droplet 134 is flatter and has a lower profile than the droplet 104 of FIG. 1A. Electrowetting can be used to change the apparent contact angle of the droplet 104 with respect to the surface 108.

The concept of electrowetting relies on the ability to electrically alter the apparent contact angle that a liquid forms with respect to a surface with which the liquid is in contact. The electric field may be applied at a buried electrode (not shown in FIG. 1B) underneath the surface 108, along with another electrical connection to the droplet 104, or second buried electrode. Electrowetting can be conceptualized as a body effect on the liquid where the liquid is being forced to change position, and possibly translate, in response to an electric field. In changing position and/or translating, the capacitive energy of the system is maximized. The surface tension force attempts to maintain the droplet 104 in a spherical shape and prevents the liquid from spreading even further. The droplet 104 will be static when all the forces acting on the droplet 104 sum to zero.

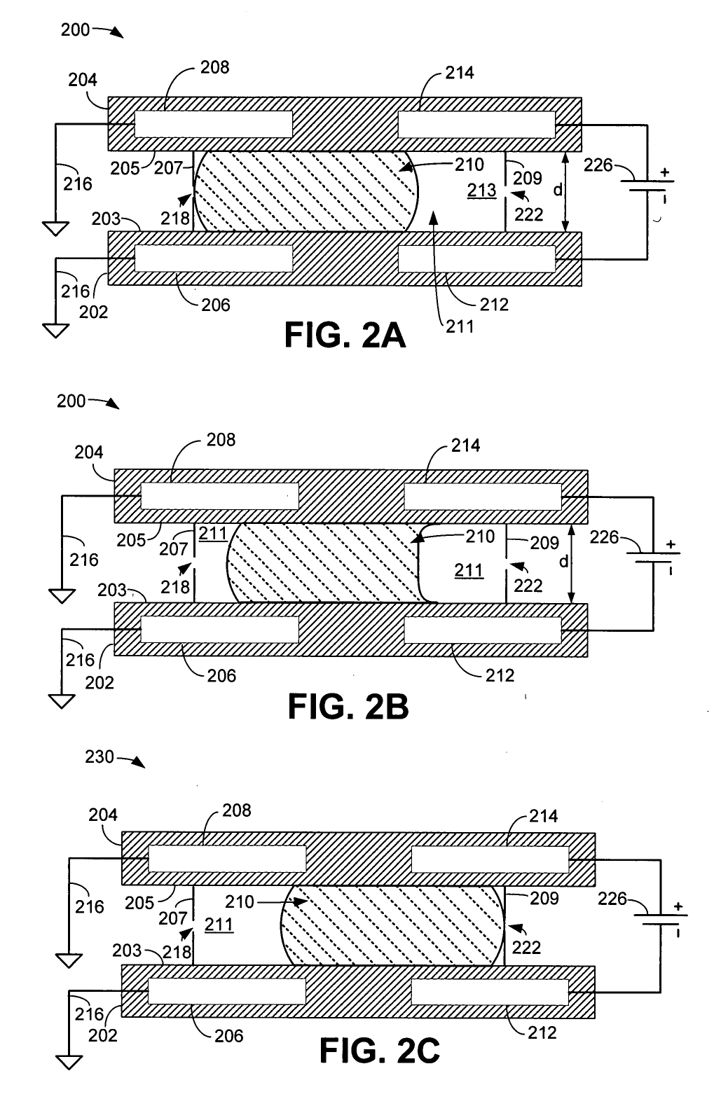

FIG. 2A is a schematic diagram illustrating an embodiment of a switch 200 employing a conductive or dielectric liquid droplet that translates over a distance. The switch 200 includes a dielectric 202 having a surface 203 forming the floor of the switch, and a dielectric 204 having a surface 205 that forms the roof of the switch. Shown schematically are wall portions 207 and 209 that, together with the surface 203 and surface 205, form a fluid cavity 211. The wall portion 207 includes a fluid port 218 and the wall portion 209 includes a fluid port 222. A droplet 210 of a liquid is sandwiched between the dielectric 202 and the dielectric 204. The fluid ports 218 and 222 are covered and uncovered by the movement of the droplet 210.

The area remaining within the fluid cavity 211 is filled with a primary fluid 213. The primary fluid 213 may be a liquid or a gas. The primary fluid 213 forms the atmosphere around the droplet 210. The conductive and/or dielectric characteristics of the primary fluid 213 are different from the conductive and/or dielectric characteristics of the secondary liquid forming the droplet 210 so that electrowetting has preferential effect to either the primary fluid or the secondary liquid. The primary fluid 213 should be wetting with respect to the surfaces 203 and 205, and with respect to the surfaces of the wall portions 207 and 209, so that the primary fluid 213 can be loaded into the switch by capillary action and can easily flow through the switch 200.

Although omitted for clarity in FIG. 2A, the fluid cavity 211 also includes one or more ports and vents that are used to load the liquid droplet into the fluid cavity 211. The ports and vents can be sealed after the introduction of the liquid droplet. The liquid droplet can be loaded into the fluid cavity 211 as described in co-pending, commonly-assigned U.S. patent application Ser. No. 11/130,846, entitled “Method and Apparatus for Filling a Microswitch with Liquid Metal,” attorney docket no. 10041453-1, which is incorporated herein by reference.

The dielectric 202 includes an electrode 206 and an electrode 212. The dielectric 204 includes an electrode 208 and an electrode 214. The electrodes 206 and 212 are buried within the dielectric 202 and the electrodes 208 and 214 are buried within the dielectric 204. The electrodes 206, 208, 212 and 214 are used to apply electric fields that induce forces on the droplet. The forces impart motion to the droplet 210. In this example, and to induce the droplet 210 to move toward the electrodes 212 and 214, the electrodes 206 and 208 are coupled to an electrical return path 216 and are electrically isolated from electrodes 212 and 214, and the electrodes 212 and 214 are coupled to a voltage source 226. Alternatively, to induce the droplet 210 to move toward the electrodes 206 and 208, the electrodes 212 and 214 can be coupled to an isolated electrical return path and the electrodes 206 and 208 can be coupled to a voltage source. This assumes the droplet 210 will follow the field because it is either more conductive or has higher dielectric constant than the primary fluid. If the primary fluid displaces the secondary liquid because the primary fluid has a higher conductivity or dielectric constant, this will also work to induce translation of the droplet, albeit with reversed operation of the pairs of electrodes.

Electrowetting imparts motion to a fluid to maximize the capacitance of the system. In simple terms, the capacitive energy of the system is:

$$U = \frac{{CV}^{2}}{2}$$

where C is the capacitance, and V is the voltage applied to the liquid using the buried electrodes. If a conductive or dielectric droplet displaces to more fully cover the area just above the buried electrodes, the capacitance increases, and thus, the stored energy increases. The force on the droplet is:

$$F = \frac{d U}{d x}$$

where x is the displacement of the droplet leading to the change in stored capacitive energy.

FIG. 2B is a schematic diagram illustrating the movement imparted to a droplet of liquid as a result of electrowetting forces on the droplet 210. When a voltage is applied to the electrodes 214 and 212 by the voltage source 226, the forces imparted to the droplet 210 due to electrowetting cause the droplet 210 to translate across the surfaces 203 and 205, thus uncovering the fluid port 418.

FIG. 2C is a schematic diagram 230 illustrating the switch 200 of FIG. 2A after the application of a voltage. As shown in FIG. 2C, the droplet 210 has moved across the surfaces 203 and 205, now covering the fluid port 222. In this manner, electrowetting can be used to induce translation in a conductive and/or dielectric liquid and can be used to open and close fluid ports in a switch.

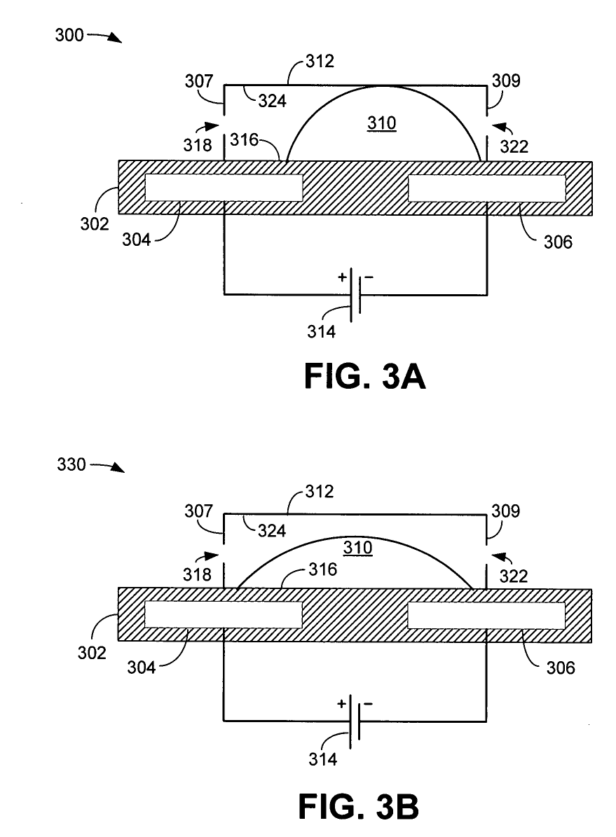

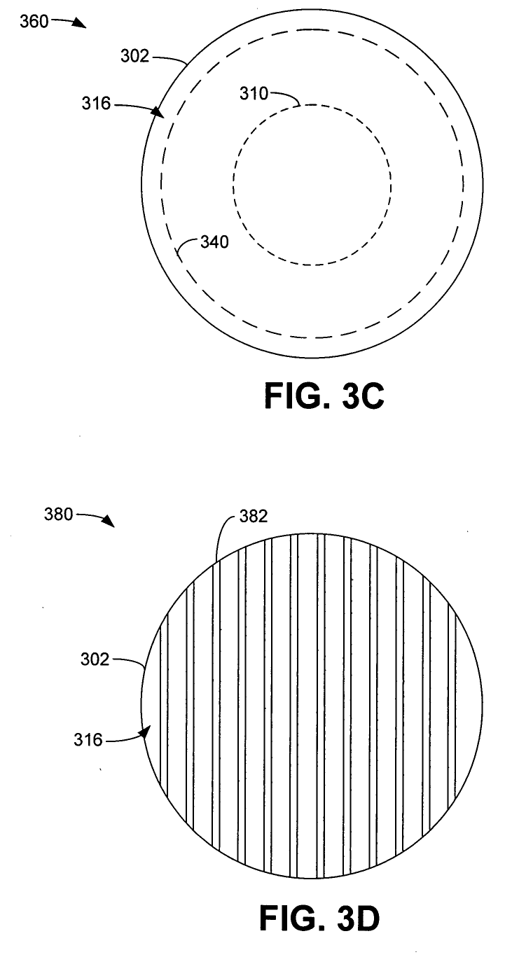

FIG. 3A is a schematic diagram illustrating an embodiment of a switch 300 employing a conductive or dielectric liquid droplet that changes position by changing shape. The droplet 310 rests on a surface 316 of a dielectric 302. The dielectric 302 can be, for example, tantalum oxide or another suitable dielectric thin film and the droplet 310 can be mercury, a gallium alloy, or another conductive and/or dielectric liquid. Wall portions 307 and 309 are shown schematically as residing on the surface 316 of the dielectric 302. The wall portion 307 includes a fluid port 318 and the wall portion 309 includes a fluid port 322. A roof portion 312 contacts the wall portions 307 and 309 and forms a fluid cavity 311. The droplet 310 is in physical contact with the surface 316 of the dielectric 302 and with the surface 324 of the roof portion 312 and the wall portions 307 and 309. The surface 316 of the dielectric 302, the surface 324 of the roof portion 312 and the surfaces of the wall portions 307 and 309 can also be at least partially covered with one or more features that influence the contact angle formed by the droplet 310 with respect to the surface 316. Examples of features that influence the contact angle formed by the droplet 310 with respect to the surface 316 include the type of material that covers the surface 316, the patterning of a wetting material formed over a non-wetting surface, and microtexturing to alter the wettability of portions of the surfaces 316, 324, the surfaces of the wall portions 307 and 309, etc. These features will be described below.

The dielectric 302 also includes an electrode 304 and an electrode 306 coupled to a voltage source 314. The electrodes 304 and 306 are buried within the dielectric 302. With no electrical bias, the droplet 310 conforms to a prespecified shape that can be determined by controlling the contact angle between the surface 316 and the droplet 310, as mentioned above. While the droplet 310 is located over the electrodes 304 and 306, it should be understood that the term “over” is meant to describe a spatially invariant relative relationship between the droplet 310 and the electrodes 304 and 306. Moreover, the droplet 310 is located proximate to the electrodes 304 and 306 so that if the switch 300 were inverted, the droplet 310 would still be proximate to the electrodes 304 and 306 as shown. Further, the relationship between the droplet and the electrodes in the embodiments to follow is similarly spatially invariant.

FIG. 3B is a schematic diagram illustrating the switch 300 of FIG. 3A under an electrical bias. In FIG. 3B, an electrical bias is applied by the voltage source 314 to the electrodes 304 and 306. The electrical bias establishes an electric field that passes through the droplet 310, thus causing the droplet 310 to deform as shown in FIG. 3B. The applied bias alters the apparent contact angle between the droplet 310 and the surface 316, thus causing the droplet to flatten and pull away from the surface 324. In this manner, a fluid path is opened to fluidically connect the fluid port 318 and the fluid port 322. In this manner, a simple fluid switch is formed that uses electrowetting to alter the position of the droplet by changing the shape of the droplet 310 to fluidically connect the fluid port 318 and the fluid port 322.

When an electrical bias is applied to the electrodes 304 and 306, the droplet completes a capacitive circuit between the electrodes 304 and 306 and if the dielectric is of constant thickness, the applied voltage is evenly distributed causing the same change in apparent contact angle of the droplet 310 over both electrodes 304 and 306, when the droplet covers both electrodes substantially evenly. In this example, when the bias is removed, the droplet 310 will return to its original state as shown in FIG. 3A, and close the fluid connection between the fluid ports 318 and 322. The embodiment shown in FIGS. 3A and 3B is referred to as a “non-latching” switch in that the droplet returns to its original state when the bias voltage is removed, thus closing the fluid connection between the fluid ports 318 and 322.

FIG. 3C is a plan view 360 illustrating the switch shown in FIGS. 3A and 3B. The droplet 310 under no electrical bias is shown in the center of the surface 316, while the droplet 340, which is under an electrical bias, is shown spread out over the surface 316.

FIG. 3D is a plan view 380 illustrating the surface 316 of the dielectric 302 including a feature that alters the wettability of the surface with respect to the droplet. In this example, the surface 316 of the dielectric 302 is silicon dioxide (SiO₂) to which strips of a wetting material 382 have been applied to alter the initial contact angle between the droplet 310 and the surface 316, thus forming an intermediate contact angle for the droplet 310.

Further, microtexturing, which is the formation of small trenches in the surface 316 can also be applied to alter the contact angle between the surface 316 and the droplet 310. In this manner, an initial contact angle can be established between the surface 316 and the droplet 310. By defining an initial contact angle, the contact angle change due to the application of an electrical bias can be closely controlled, thereby allowing control over the switching function.

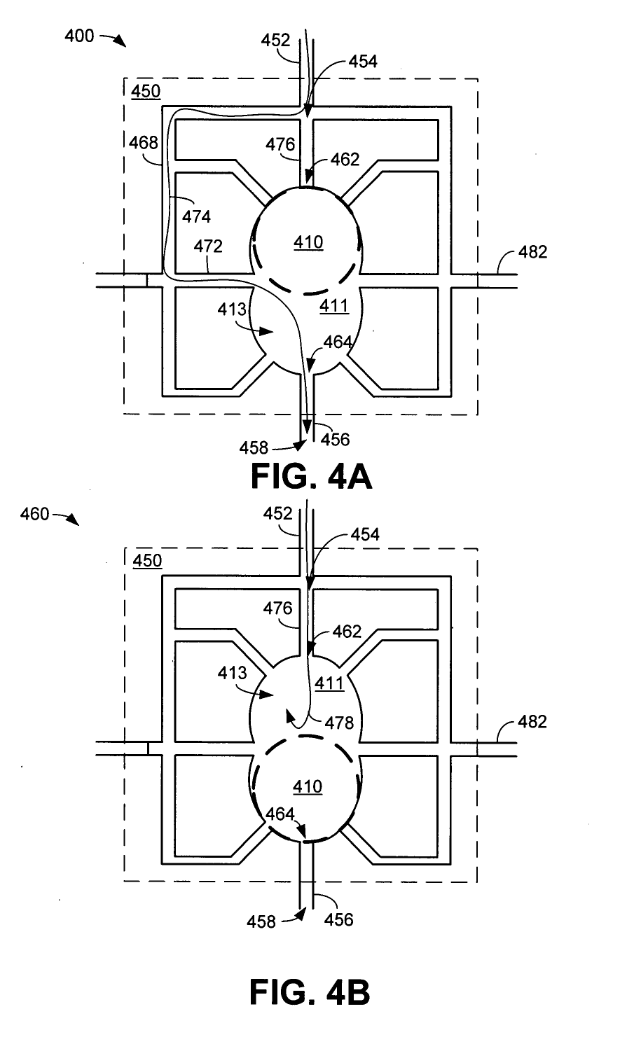

FIG. 4A is a schematic diagram 400 illustrating an embodiment of a switch element 450. A microfluidic channel 452 is coupled to an inlet 454 of a switch element 450. The switch element 450 includes a plurality of microfluidic channels, exemplary ones of which are illustrated using reference numerals 468, 472, 476 and 456. The switch element 450 includes a fluid port 462 and a fluid port 464. In this example, the fluid port 462 is referred to as an “inlet” port and a fluid port 464 is referred to as an “outlet” port. However, this designation is arbitrary. The fluid port 462 is coupled to the inlet 454 via the microfluidic channel 476. The fluid port 464 is coupled to an outlet 458 via a microfluidic channel 456.

The switch element 450 also includes a droplet 410 of a conductive or dielectric liquid, referred to as a secondary fluid, residing within a cavity 411. In this example, the droplet 410 is a liquid. The secondary liquid can be inserted into the cavity 411 through a fill port 482. The fill port 482 can be sealed after the addition of the secondary liquid. During operation, the cavity 411 also contains a quantity of primary fluid 413, as described above. The droplet 410 can be contained in the cavity 411 by its surface tension of the secondary liquid and the non-wettability of the secondary liquid to the interior surfaces of the cavity 411, which leads to capillary repulsion. A roof is omitted from the switch element 450 of FIG. 4A for simplicity of illustration. In this example, the primary fluid 413 is the fluid that travels through the microfluidic channel 452 into the switch element 450.

In the embodiment shown in FIG. 4A, the droplet 410 is located in a first position within the cavity 411 such that the fluid port 462 is blocked and the fluid port 464 is exposed. Because the fluid port 464 is exposed, the primary fluid 413 can travel through the microfluidic channels 452, 468, and 472 into the cavity 411 and then exit the switch element 450 through the fluid port 464. The primary fluid 413 then travels through the microfluidic channel 456 and into the outlet 458. The flow of the primary fluid 413 is illustrated using the arrow 474.

FIG. 4B is a schematic diagram 460 illustrating the switch element 450 of FIG. 4A in a second state. In FIG. 4B, the electrowetting effect has caused the droplet 410 to translate across the cavity 411 to a second position so that the fluid port 464 is blocked by the droplet 410. The switch element 450 shown in FIG. 4B is said to be in the blocked state. As shown in FIG. 4B, and using the arrow 478 for illustration, the flow of primary fluid 413 through the inlet 454 via the microfluidic channel 476 is blocked by the droplet 410 because the droplet 410 is covering the fluid port 464. In this manner, causing the droplet 410 to switch between the first position shown in FIG. 4A and the second position shown in FIG. 4B controls the flow of the primary fluid 413 through the switch element 450. The surface tension and capillary repulsion of the secondary liquid with respect to the primary fluid is designed to support the pressure gradient when the droplet 410 is in the position shown in FIG. 4B and such that the secondary liquid will not be driven through the fluid port 464. An example of actuation mechanism that can cause the droplet 410 to traverse the cavity 411 will be described below. Each of the positions shown in FIGS. 4A and 4B is said to be a “latching” position because the droplet will only move when actuated. The architecture shown in FIGS. 4A and 4B is not intended to be limiting.

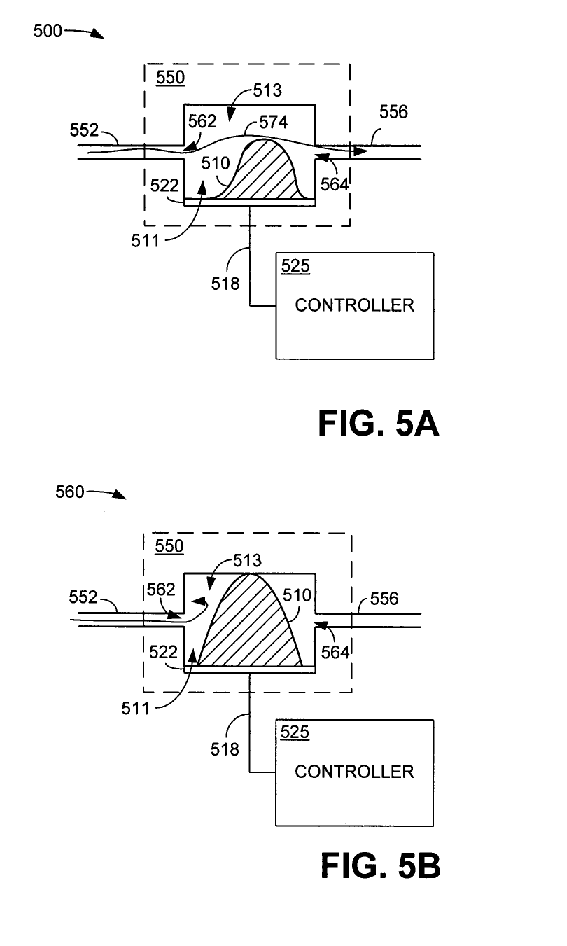

FIG. 5A is a schematic diagram 500 illustrating an alternative embodiment of a switch element 550. The switch element 550 includes a fluid port 562, referred to as an “inlet” port, and a fluid port 564, referred to as an “outlet” port. The fluid port 562 is coupled to a microfluidic channel 552 and the fluid port 564 is coupled to a microfluidic channel 556. The switch element 550 also includes a cavity 511 in which a droplet 510 is located. The droplet 510 is similar to the droplets described above. In this example, the droplet 510 is formed from a conductive or dielectric secondary liquid. The switch element 550 also includes electrodes 522. The electrodes 522 are illustrated as a single electrode; however, the electrodes 522 comprise a sufficient number of electrodes to impart motion to the droplet 510 to cause the droplet 510 to change shape based on the electrowetting effect. As described above, the droplet 510 comprises a secondary liquid located within the primary fluid 513.

As shown in FIG. 5A, the droplet 510 is in a first position that allows the primary fluid 513 to flow through the cavity 511 from the fluid port 562 to the fluid port 564, as illustrated using arrow 574. The output of the fluid port 564 is coupled through a microfluidic channel 556 to other elements associated with the switch element. A controller 525 is coupled to the electrodes 522 via connection 518. Depending on a variety of inputs, the controller 525 controls the electrodes 522 to determine the position of the droplet 510 to control the flow of the primary fluid 513 through the switch element 550. In an embodiment, the droplet remains stationary and the position of the droplet 510 is changed between two states shown in FIGS. 5A and 5B by changing the shape of the droplet 510.

FIG. 5B is a schematic diagram 560 showing the switch element 550 in a second state. As shown in FIG. 5B, the droplet 510 is caused to change position so that the flow of primary fluid 513 through the switch element 550 is blocked by the droplet 510. In this manner, the shape of the droplet 510 determines its position and thus controls the flow of primary fluid 513 through the switch element 550. A similar controller 525 can be used to control the switch 450 described above.

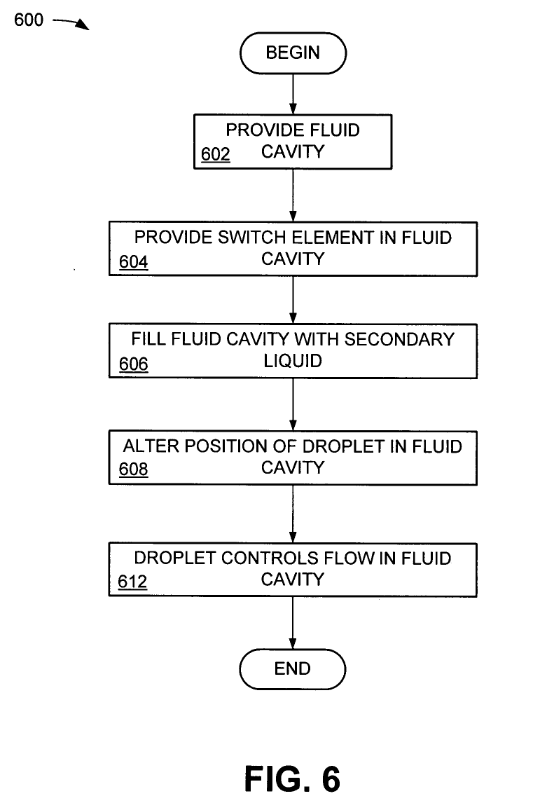

FIG. 6 is a flowchart 600 describing a method for controlling fluid flow in a microfluidic circuit. In block 602 a fluid cavity is provided. In block 604 a switch element is provided in the fluid cavity. In block 606, the fluid cavity is filled with a secondary fluid. In block 608, an actuation source is activated to alter the position of the droplet in the fluid cavity so that the droplet assumes one of two positions. In block 612, the droplet controls the flow of a primary fluid through the fluid cavity.

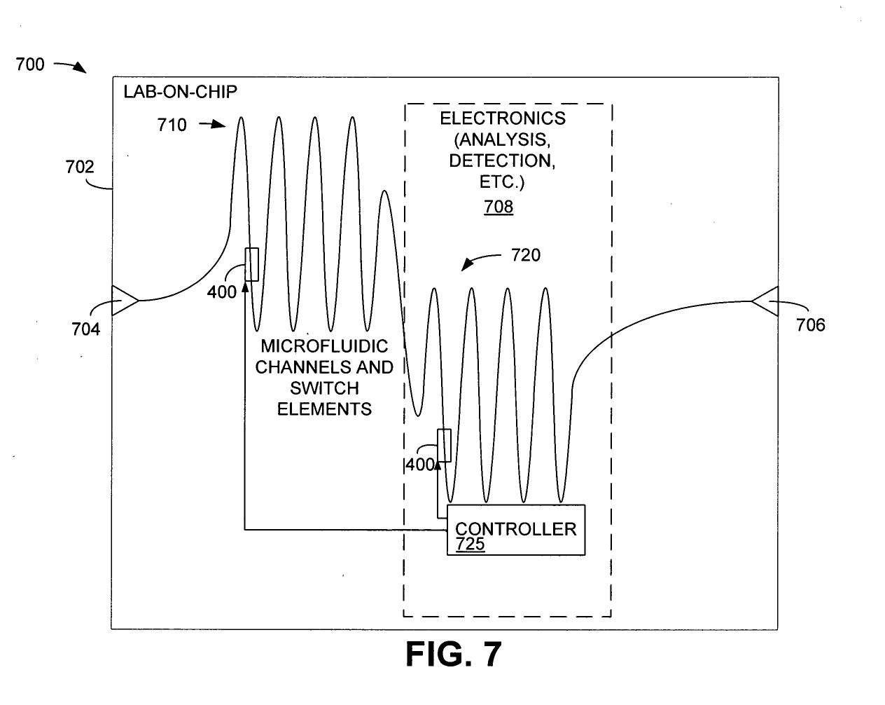

FIG. 7 is a block diagram illustrating a simplified lab on chip, which is an exemplary device in which one or more of the switch elements described above may be implemented. A lab on chip is a term given to a device that integrates multiple laboratory functions on a single chip that is usually a few square millimeters to a few square centimeters in size and that is capable of handling extremely small fluid volumes on the order of less than one pico liter. Typically a lab on chip device is manufactured using micromachining technology and is sometimes referred to as a micro total analysis system (μTAS). A lab on chip typically refers to the scaling of single or multiple laboratory processes down to a chip format. Examples of laboratory processes that may be scaled to a lab on chip format include pumping, mixing, flow control, sensing, etc.

In this example, the lab on chip 700 includes a substrate 702 on which a variety of elements can be fabricated. In an embodiment, an inlet 704, an outlet 706 and microfluidic channels and switch elements 710 and 720 are fabricated on one or more layers of the substrate 702 using micromachining techniques. The microfluidic channels and switch elements 710 and 720 can include one or more instances of switch elements described above. In an embodiment, the microfluidic channels and switch elements 710 and 720 include two instances of the switch element 400 described above. However, many additional instances of the switch element 400 can be included on the lab on chip 700.

The lab on chip 700 also includes electronics 708. The electronics 708 may include the ability to perform various processing functionality, depending on the operations performed by the lab on chip 700. The electronics 708 is shown as a dotted line to indicate that it may be fabricated one of a number of different layers of the lab on chip 700. The electronics 708 may include a controller 725 for controlling the switch elements 400, as described above.

This disclosure describes embodiments in accordance with the invention in detail. However, it is to be understood that the invention defined by the appended claims is not limited to the precise embodiments described.

What is claimed is:

1. A system for controlling fluid flow in a microfluidic circuit, comprising:
at least one microfluidic channel having a first fluid;
a switch element coupled to the microfluidic channel, the switch element comprising at least one inlet, at least one outlet and a second fluid, the second fluid being immiscible with respect to the first fluid; and
an actuator configured to alter the position of the second fluid, such that when in a first position, the second fluid allows the first fluid to flow from the at least one inlet to the at least one outlet, and such that when in a second position, the second fluid prevents the first fluid from flowing from the at least one inlet to the at least one outlet.

2. The system of claim 1, in which the actuator further comprises at least one electrode and a voltage source and the position of the second fluid is changed by an electrowetting effect.

3. The system of claim 1, in which the position of the second fluid is altered to maximize the capacitance of the system, under the effect of electrowetting.

4. The system of claim 2, in which the position of the second fluid is changed to move the second fluid between a first position and a second position, wherein the first position allows the first fluid to flow from the at least one inlet to the at least one outlet, and wherein the second position prevents the first fluid from flowing from the at least one inlet to the at least one outlet.

5. The system of claim 1, in which the first fluid is chosen from deionized water, water with a salt, water with a surfactant, water with sodium dodecyl sulfate and the second fluid is chosen from an oil, mercury, gallium, and gallium alloy.

6. The system of claim 1, in which the microfluidic circuit is part of a lab on chip device.

7. The system of claim 4, in which the second fluid translates over a distance.

8. The system of claim 4, in which the profile of the second fluid changes while the second fluid remains stationary.

9. A method for controlling fluid flow in a microfluidic circuit, comprising:
providing at least one microfluidic channel having a first fluid;
providing a switch element coupled to the microfluidic channel, the switch element comprising at least one inlet, at least one outlet and a second fluid, the second fluid being immiscible with respect to the first fluid; and
altering the position of the second fluid, such that when in a first position, the second fluid allows the first fluid to flow from the at least one inlet to the at least one outlet, and such that when in a second position, the second fluid prevents the first fluid from flowing from the at least one inlet to the at least one outlet.

10. The method of claim 9, in which altering further comprises:
providing an actuator comprising at least one electrode and a voltage source; and
changing the position of the second fluid using an electrowetting effect.

11. The method of claim 9, in which the position of the second fluid is altered to maximize the capacitance of the first fluid and the second fluid under the effect of electrowetting.

12. The method of claim 10, in which changing the position of the second fluid moves the second fluid between a first position and a second position, wherein the first position allows the first fluid to flow from the at least one inlet to the at least one outlet, and wherein the second position prevents the first fluid from flowing from the at least one inlet to the at least one outlet.

13. The method of claim 9, in which the first fluid is chosen from deionized water, water with a salt, water with a surfactant, water with sodium dodecyl sulfate and the second fluid is chosen from an oil, mercury, gallium, and gallium alloy.

14. The method of claim 9, in which the microfluidic circuit is part of a lab on chip device.

15. The method of claim 12, further comprising translating the second fluid over a distance.

16. The method of claim 12, further comprising changing the profile of the second fluid while the second fluid remains stationary.

17. A system for controlling fluid flow in a microfluidic circuit located on a lab-on-chip, comprising:
at least one microfluidic channel having a first fluid;
a switch element coupled to the microfluidic channel, the switch element comprising at least one inlet, at least one outlet and a second fluid, the second fluid being immiscible with respect to the first fluid; and
an actuator configured to alter the position of the second fluid, such that when in a first position, the second fluid allows the first fluid to flow from the at least one inlet to the at least one outlet, and such that when in a second position, the second fluid prevents the first fluid from flowing from the at least one inlet to the at least one outlet.

18. The system of claim 17, in which the actuator further comprises at least one electrode and a voltage source and the position of the second fluid is changed by an electrowetting effect.

19. The system of claim 17, in which the position of the second fluid is altered to maximize the capacitance of the system, under the effect of electrowetting.

20. The system of claim 18, in which the position of the second fluid is changed to move the second fluid between a first position and a second position, wherein the first position allows the first fluid to flow from the at least one inlet to the at least one outlet, and wherein the second position prevents the first fluid from flowing from the at least one inlet to the at least one outlet.

21. The system of claim 20, in which the second fluid translates over a distance.

22. The system of claim 20, in which the profile of the second fluid changes while the second fluid remains stationary.
